(19) United States
(12) Patent Application Publication
(10) Pub. No.: US 2020/0277214 A1
(43) Pub. Date: Sep. 3, 2020

(54) TEXTURED TRANSPARENT SUBSTRATE, IN PARTICULAR FOR GREENHOUSE USE

(71) Applicant: SAINT-GOBAIN GLASS FRANCE, COURBEVOIE (FR)

(72) Inventors: Gilles COURTEMANCHE, CHEVREUSE (FR); Christian TÜLLMANN, LADENBURG (DE); Lucia ALVAREZ RODRIGO, OVIEDO (ES); Tatiana SEVERIN-FABIANI, CACHAN (FR); Delphine DESCLOUX, PARIS (FR)

(21) Appl. No.: 16/646,457

(22) PCT Filed: Sep. 17, 2018
(86) PCT No.: PCT/FR2018/052277

§ 371 Date: Mar. 11, 2020

(30) Foreign Application Priority Data
Sep. 15, 2017 (FR) 1770968

(51) Int. Cl. C03B 13/08; C03B 13/16; C03C 3/078; C03C 3/087; G02B 5/02; G02B 1/10; A01G 9/14

(52) U.S. Cl. CPC C03B 13/08; C03B 13/16; C03C 3/078; C03C 3/087; A01G 2009/1484; G02B 5/0215; G02B 1/10; A01G 9/14; G02B 5/0278

(57) ABSTRACT

A transparent substrate includes a texture in relief on at least one of its two main faces, such that when the substrate is textured on a single face, the average slope Pₘ in degrees of this textured face is lower than 2°, and when the substrate is textured on both its faces, the sum of the two average slopes (Pm1, Pm2) of the respective faces is lower than 3°.

The invention relates to a weakly scattering textured substrate of high transparency, in particular for horticultural greenhouses.

The invention will be more particularly described with regard to a transparent substrate for horticultural greenhouses, without however being limited thereto, and is applicable to any application requiring a high hemispherical transmission (TLH), a high light transmission (TL) and a low haze (H).

With regard to the application of greenhouses to horticulture, glazings of smooth surface are mainly used because of their very high hemispherical light transmission. Usually, a smooth surface is a surface for which surface irregularities are of dimensions smaller than the wavelength of the radiation incident on the surface, so that the radiation is not deviated by these surface irregularities. The incident radiation is then transmitted specularly (or regularly) by the surface so that radiation incident on the glazing with a given angle of incidence is transmitted by the glazing with an angle of transmission dependent on the angle of incidence. In theory, specular transmission involves an incident ray being transmitted in the form of a single ray. In practice, a transmitted ray always comprises a diffuse component, the latter however being negligible in the case of so-called specular transmission.

It is known to manufacture glazings with smooth surfaces on both the faces thereof and of high light transmission from flat float glass, the float process consisting in pouring the glass ribbon output from a furnace onto a bath of metal such as tin.

Glazings of smooth surface, because of their specular transmission, have the drawback of concentrating the transmitted light rays into localized hotspots. Certain types of crops may suffer as a result of the existence of such hotspots and/or of nonuniform lighting within the greenhouse.

In this context, it is known to employ textured glasses, for which the surface irregularities vary on a scale larger than the wavelength of the radiation incident on the surface. The incident radiation is then transmitted diffusely by these surfaces. Usually, the transmission by a glazing is said to be diffuse when radiation incident on the glazing with a given angle of incidence is transmitted by the glazing in a plurality of directions. This diffuse transmission has a positive impact on the horticultural production of the aforementioned sensitive crops. Thus, the effect of scattering prevents hotspots on the plants and allows light to better penetrate into all the zones of the greenhouse. In other words, it allows more uniform lighting to be obtained.

The texture of such glasses is obtained by a rolling process, at least one of the metal cylinders possessing a textured surface that corresponds to the negative of the texture to be obtained on at least one face of the glass. The patterns of the texture (reliefs protruding with respect to the surface of the flat glass output from manufacture) are for example bumps or prisms such as cones or pyramids able to be inscribed at the base of the substrate in a circle. The patterns in relief (texture) are generated by holes/cavities/punctures, produced generally in circular shapes, formed at the surface and in the thickness of the substrate, and obtained by rolling with rollers possessing features in relief.

Throughout this text, the average slope (Pm) of the texture patterns has been measured with an apparatus sold by the company STIL and referenced Micromesure 2™. The period (Rsm) and the height (Rz) of the patterns were for their part measured according to standard ISO 4287:1997 with an apparatus referenced Mitutoyo SJ-400™, this apparatus being equipped with a 1400 mm stylus and implementing Gaussian filters with cut-offs at 25 μm and 8 mm (suppression of periods lower than 25 μm and higher than 8 mm).

It will be recalled that the period Rsm of a profile (i.e. along a straight-line segment) of a surface is defined by the relationship:

$$Rsm = \frac{1}{n} {\sum }_{i = 1}^{i = n} Si = \frac{S 1 + S 2 + ⋯ + Sn}{n}$$

in which Si is the distance between two upward passages through zero (median line), n+1 being the number of upward passages through zero in the profile in question. This parameter Rsm is representative of the distance between peaks, i.e. of the pitch of the texture parallel to the general plane of the substrate. The Rsm measurements were carried out over a distance of at least 40 mm. For any point of the textured surface, the Rsm about said point corresponds to the arithmetic mean of the Rsm values of 10 profiles arranged in a star centered on the point in question. For the calculation of the Rsm about a point, values higher than or equal to 40 mm are removed. This avoids taking into account the profiles in certain directrice lines of particular textures such as those of parallel prisms or of straight lines between aligned pyramids (infinite or uncalculatable Rsm value). An average Rsm is also defined for a textured surface by calculating the arithmetic mean of the Rsm values about a point, the points being chosen on a square grid with a pitch of 5 cm.

It will be recalled that the height Rz of a profile, i.e. along a straight-line segment, of a surface is the average of the five largest heights of the profile. By height what is meant is the distance between the highest peak and the lowest valley over a sampling length of the profile. The parameter Rz is therefore representative of the average maximum height of the profile.

The high transmission sought for greenhouse glazings is the transmission that is called hemispherical transmission (TLH, sometimes denoted T_{H}EM), i.e. the transmission averaged over a plurality of angles of incidence. For each angle of incidence, all the light intensity passing through the glazing is measured whatever the angle of emergence. As to the strong scattering and uniform distribution of the light that are sometimes also sought, they correspond to the haze of the glazing, which is given by the haze value, called H. Haze is the ratio between the diffuse transmission and the total transmission of the glazing. Throughout this description, TLH and haze have been measured using the methods detailed in “Proc 7th IS on light in Horticultural Systems, Eds: S. Hemming and E. Heuvelink, Acta Hort.956, ISHS 2012”. In this document, mention is made of a haze measured at 1.5°. However, in the field of transparent materials, haze is often measured at 2.5°. One standard has not yet been entirely agreed in the field of greenhouses for horticulture, although haze at 1.5° is at the present time more widely used, in particular by the University of Wageningen (WUR) which is recognized in the field of horticultural research.

Patent application WO2016/170261, filed in the name of the Applicant, describes textured glasses developed with the aim of achieving very high haze values, higher than 60%, with a limited loss of TLH. These glasses are in particular intended to differ from the glass of brand Albarino-T™, sold by the Saint-Gobain group, the haze of which is judged to be too low. It will be noted that the glass of brand Albarino-T™ is textured on its two opposite faces by hot rolling between two textured rollers. As specified in the examples, its faces respectively comprise texture patterns of a Pm of 2° and of 1.5°, the sum of the two average slopes therefore being equal to 3.5°, for a haze in transmission of a value of 20% at 1.5°.

Textured glasses such as those described in WO2006/170261 have the drawback of having a lower hemispherical light transmission compared to the same glass but untextured, this being contrary to the primary function sought for a glass of high light transmission for horticultural production. It will be noted that a gain or a loss of 1% of TLH is already very noticeable.

In the context of horticultural production, there is therefore a need for a textured substrate that has a hemispherical transmission TLH close to that of a float glass with smooth surfaces.

The present invention meets this need, and relates in at least one particular embodiment to a transparent substrate comprising a texture in relief on at least one of its two main faces, such that

when the substrate is textured on a single face, the average slope Pₘ in degrees of this textured face is lower than 2°, and

when the substrate is textured on both its faces, each of the faces having a respective average slope (Pm1, Pm2), the sum of the two average slopes of the respective faces is lower than 3°, and preferably lower than 2.5°.

Throughout this text, the slope at a point on the surface of a sheet designates the angle formed between the plane tangent to this point and the general plane of the substrate. The measurement of the slope at a point is carried out on the basis of the measurement of the variation in height in the vicinity of this point and with respect to the general plane of the substrate. The average slope Pm of the surface is determined on the basis of the measurement of slope at points distributed over a surface in a square grid of 20 μm period.

A substrate according to the invention has a very high hemispherical transmission TLH, and thus approaches that of a float glass with smooth surfaces, while preserving a textured surface. This hemispherical transmission TLH increases at the same time as the haze decreases, and vice versa. These two quantities being related to surface roughness, and more precisely to the average slope Pm of the latter, the invention is based on a novel and inventive concept consisting in setting an upper limit for the value of average slope Pm, allowing the obtainment of a satisfactory, because minimal, haze to be guaranteed. In this context, it has been determined that a slope value lower than 2° allows a surface the haze of which is lower than 10% at 1.5°, which is judged to be satisfactory, to be obtained. Such a surface has a fine and discrete texturing made up of closely spaced patterns.

The same reasoning is applied to glasses having a texturing of their two opposite faces, on the basis of the sum of their average slopes.

According to one particular embodiment, the substrate is characterized in that:

when the substrate is textured on a single face, the average slope Pm in degrees of this textured face is lower than 1.8°, preferably lower than 1.7°, more preferably lower than 1.6°, more preferably lower than 1.5°, more preferably lower than 1.4°, and more preferably lower than 1.3°,

when the substrate is textured on both its faces, each of the faces having a respective average slope (Pm1, Pm2), the sum of the two average slopes of the respective faces is lower than 2.5°, preferably lower than 2.1°, more preferably lower than 1.9°, more preferably lower than 1.7°, more preferably lower than 1.5°, and more preferably lower than 1.3°.

To the same end of minimizing haze, and maximizing hemispherical transmission TLH, the upper limiting value of haze to be obtained is preferably set to 5% at 1.5°, and preferably to decreasing values of haze. The limiting values of average slope Pm or of sums of average slopes (Pm1, Pm2) claimed above allow these haze values to be obtained.

According to one particular embodiment, the refractive index of the material comprising the texture is comprised between 1.4 and 1.65 at a wavelength of 587 nm.

According to one particular embodiment, the material comprising the texture is made of mineral glass, and preferably comprises iron oxide in a total weight content (expressed in Fe₂O₃) of at most 0.030%, in particular of at most 0.020%, or even 0.015%, and is preferably of the soda-lime-silica type with the following weight composition:

SiO₂ 50-75%

CaO 5-15%

MgO 0-10%

Na₂O 10-20%

Al₂O₃ 0-5%

K₂O 0-5%.

The present features relate to extra-clear glasses, and more particularly to the Diamant™ and Albarino™ glazing matrices sold by Saint-Gobain. These glass substrates have the advantage of having a light transmission higher than 90.5%, more preferably higher than 90.8%, more preferably higher than 91.0%, more preferably higher than 91.2%, and more preferably higher than 91.4%. They thus differ from so-called “clear” glasses the light transmission of which is generally lower than 90%. Throughout this text, light transmission is measured in % according to standard NFEN410-2011 (illuminant D65; 2° observer) with a Lambda950™ spectrometer from Perkin Elmer.

According to one particular embodiment, the texture of said at least one substrate comprises patterns the period of which is such that the average Rsm is lower than 5 mm, preferably lower than 2 mm, more preferably lower than 900 μm, more preferably lower than 850 μm, more preferably lower than 800 μm, more preferably lower than 750 μm, more preferably lower than 700 μm, more preferably lower than 650 μm, more preferably lower than 600 μm, and more preferably lower than 550 μm.

The surface of a substrate, whether it is smooth or textured, may comprise deformations taking the form of undulations having a very long period, of about 10 mm. During the roughness measurements, these undulations are removed by the implementation of Gaussian filters with a cut-off above a given value of period (in the present case, 8 mm). These undulations are generally masked from the sight of an observer by the texturing of the surface in question.

However, surprisingly, it has been observed that in the specific case of a haze lower than 10% at 1.5°, optical defects related to the presence of surface undulations may appear in the sight of an observer, in particular when the Rsm is higher than 900 μm. This is explained by the fact that, below a certain degree of texturing, the haze of the transmitted ray no longer allows the presence of these undulations to be optically masked. The adoption of Rsm values lower than 900 μm advantageously allows these optical defects to be limited, as these Rsm values decrease. The threshold value of 900 μm was obtained empirically by measuring using a roughness tester the values obtained on a glass exhibiting this effect and rolled with two smooth rollers.

Nothing led it to be believed that this technical problem, or indeed the proposed technical solution for remedying it, existed. On the contrary, the teachings of the prior art, including those of patent application WO2006/170261, would have incited a person skilled in the art to increase the value of the average Rsm, in order to allow the texture actually imprinted to become even closer to that of the rolling roller, and therefore limit corrections to be made to the patterns of the roller. The prior art therefore introduces a technical prejudice to be overcome to obtain the subject matter of this particular embodiment of the invention, this being an additional indication of inventive step.

According to one particular embodiment, the substrate is characterized in that: when the substrate is textured on a single face, the average slope Pm in degrees of this textured face is higher than 0.3°, preferably higher than 0.4°, preferably higher than 0.5°, more preferably higher than 0.7°, more preferably higher than 0.9°, more preferably higher than 1.0°, and more preferably higher than 1.1°,

when the substrate is textured on both its faces, each of the faces having a respective average slope (Pm1, Pm2), the sum of the two average slopes of the respective faces is higher than 0.6°, preferably higher than 0.8°, more preferably higher than 1.0°, and more preferably higher than 1.1°.

Still in the specific context of a haze lower than 10% at 1.5°, and with the objective of limiting optical defects related to the presence of surface undulations, it has been observed that the adoption of values of average slope Pm higher than 0.2° advantageously allows these optical defects to be limited, as these values of average slope Pm increase.

According to one particular embodiment, the substrate comprises an antireflection coating on one or both of its main faces, preferably placed against said at least one textured face.

This antireflection effect may be obtained by depositing a layer or a plurality of layers forming a stack, for example by deposition using a liquid sol-gel process or any other known suitable technique. The antireflection effect is chosen to be occur at the wavelengths 400-700 nm. An antireflection coating (antireflection layer or stack of layers generating an antireflection effect) generally has a thickness comprised in the domain extending from 10 to 500 nm. The antireflection layer is such that it closely follows the texture of the glass without modifying it.

According to one particular embodiment, the texture is obtained by rolling the material from which the substrate is made between two rollers, a first roller being of smooth surface and a second roller being of textured surface, or both rollers being of textured surface.

For a mineral glass, the rolling is hot, in particular in a temperature domain extending from 800 to 1300° C.

Due to the rolling process, which is a simple process, requiring installations that are easier to implement and less costly than the float process, the textured glass of the invention has characteristics extremely close to a float glass that is the glass conventionally used for horticultural greenhouses because of a very high TLH.

Moreover, the process for manufacturing by rolling permits the use of specific glazing compositions improving the optical properties of light transmission (high TL value), despite the fact that these high-light-transmission compositions cannot be used in the float process because they are incompatible with the tin bath used in the float process.

Lastly, although as known the rolling process for textureless flat glass (obtained with rollers of smooth surface) is not particularly well thought of because generally it creates localized surface defects, this drawback of the manufacturing process is not disadvantageous for the substrate of the invention. Specifically, it turns out that the low texture imprinted into the substrate allows potential localized surface defects to be avoided.

According to one particular embodiment, the substrate is made from a completely monolithic material.

According to one particular embodiment, the texture may be produced in a first material placed on a substrate of a second material.

According to this particular embodiment, the texture is produced in a first relatively thin material comprising the texture and associated with a second material giving rigidity to the whole of the substrate. It is recommended that this first material be present in a minimum thickness allowing the patterns in relief to be produced. Preferably, the difference between the refractive indices of these two materials does not exceed 0.2 and more preferably does not exceed 0.1. It is a case of association of a plurality of materials when the texture is produced by embossing a sol-gel layer deposited on a transparent substrate, in particular one made of glass.

According to one particular embodiment, the substrate may also comprise more than two materials.

According to one particular embodiment, the distribution of the texture extends over all of the surface of the substrate.

The invention also relates to a horticultural greenhouse equipped with such a substrate.

The invention also relates to a process for manufacturing such a substrate by rolling between two rollers, either between a roller of smooth surface and a textured roller with patterns, or between two textured rollers with patterns, in particular the one or more textured rollers possessing imprinting patterns having an average slope higher, preferably higher by 1°, than the average slope of the associated patterns obtained on the substrate.

The texture of the substrate, i.e. the texture obtained by rolling, depends on the shape of the patterns of the imprinting surface of the roller and on their roughness, and on parameters related to the process such as the height of the roller, the pressure exerted by the roller, the run speed of the material to be rolled.

In order to obtain the claimed average slopes of the substrate of the invention, and depending on the adjustable parameters of the process, the one or more textured rollers possess in particular imprinting patterns having an average slope higher, preferably higher by 1°, than the average slope of the associated patterns obtained on the substrate.

The invention therefore proposes producing textured horticultural glass with a rolling process with a specific texture, to replace the float glass conventionally used in this market for horticultural glass. The rolling process is economical and the glass with texturing characteristics of the invention advantageously has properties equivalent to float glass.

According to one particular embodiment, the one or more pattern-comprising textured rollers are obtained by electrical discharge machining.

Electrical discharge machining, also called EDM, is a machining process that consists in removing material from a part using electrical discharges. This process is particularly suitable for machining the special shapes that the texture of the rolling rollers is formed from, in particular because of its very good precision (tolerance +/−5 μm) and the surface-finish quality of the machined roller.

In particular, this machining process is suitable for texturing rollers than other known machining techniques using a laser or a knurling wheel, that those skilled in the art could have been incited to employ.

The present invention is now described using merely illustrative and completely nonlimiting examples of the scope of the invention, on the basis of the appended illustrations, in which

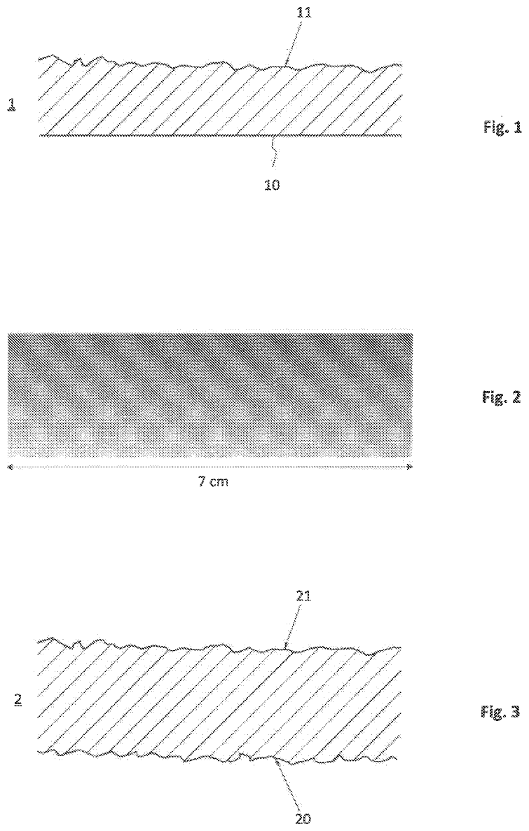

FIG. 1 shows a schematic cross-sectional view of a first example textured substrate according to the invention comprising a single textured face obtained by rolling;

FIG. 2 is a photograph from above of the example of FIG. 1;

FIG. 3 is a schematic cross-sectional view of a second example textured substrate according to the invention, comprising its two textured opposite faces.

The textures and thicknesses of FIGS. 1 and 3 are not to scale.

The textured substrates 1 and 3 illustrated in the respective FIGS. 1 and 3, in cross section along their edge face, are two respective example embodiments according to the invention, the first example substrate possessing only a single textured main face, whereas the second example has its two opposite main faces textured

The textured substrates of the invention are such that:

when the substrate is textured on a single face, the average slope Pₘ in degrees of this textured face is lower than 2°, and

when the substrate is textured on both its faces, each of the faces having a respective average slope Pm1, Pm2, the sum of the two average slopes of the respective faces is lower than 3°, and preferably lower than 2.5°.

In the embodiments illustrated in these figures, the patterns of a textured face are distributed over all the surface of the substrate.

The textured substrate 1 (example 1) is made of soda-lime-silica mineral glass of thickness comprised between 3 and 5 mm, obtained by hot rolling between two rollers the upper roller of which was of smooth surface, whereas the lower roller had a textured imprinting surface. The substrate 1 possesses its first planar face 10, and its opposite second textured face 11. The patterns in relief of the textured face 11 correspond to the patterns in negative of the textured surface (of the imprinting patterns) of the roller.

The patterns of the textured face of example 1 schematically shown in FIG. 1 and illustrated in FIG. 2 are formed of an alternating multiplicity of bumps and holes obtained using a roller comprising protruding patterns/features, here of circular base.

The roughness of the textured surface of the imprinting roller for example 1 has the following characteristics over a profile of given length, the measurements having being carried out according to standard ISO 4287:1997:

Arithmetical mean roughness of the profile: Ra=2.55 μm;

Maximum height of the profile: Rz=19.85 μm;

Average period or width of the patterns in relief of the profile (already defined above): average Rsm=191 μm;

Density of peaks per centimeter of length of the profile: RPc=52.35/cm.

The obtained substrate 1 of this example 1 has a texture in relief such that the average slope Pm is 1°. The texture is such that the period according to the average Rsm is 0.53 mm and the height Rz is 5.6 μm.

The substrate 2 of the invention (example 2) is made of a soda-lime-silica mineral glass obtained by hot rolling between two rollers of textured printing surface, the substrate possessing its two opposite textured faces 20 and 21.

The rollers used for example 2 each possess the same textured imprinting surface, the roughness of which is that defined for the roller of example 1.

The obtained substrate 2 has a texture in relief such that the average slope Pm1 of the first surface (surface obtained by the lower roller) is 1° and the average slope Pmt of the second surface (surface obtained by the upper roller) is 1°, the sum of the average slopes being 2 (Pm1+Pm2).

In table 1 below have been given for the two examples 1 and 2 of the invention and comparative examples 3 to 5 (which do not correspond to the invention), the values of the height Rz, period according to the average Rsm of the textured pattern of the substrate, average slope Pm (substrate textured on one face) or sum of the average slopes (substrate textured on both faces), the TLH of the substrate, the loss of TLH (ΔTLH), and the haze at 1.5°.

The loss of TLH is equal to the difference in TLH between that of the measured substrate and of a reference TLH of flat float glass. The flat float glass taken as reference is the glass called DIAMANT™ sold by Saint Gobain, which possesses a high TL H of 84% and a haze of 0.

Example 3, which is a comparative example, is a commercially available glass, Albarino-T™. This glass of example 3 has its two opposite faces textured via a roller of given roughness with rolling-process parameters leading to a substrate having respectively a first average slope Pm1 of 2°, and a second average slope Pmt of 1.5°, this leading the sum of its average slopes to equal 3.5°.

Example 4, which is a comparative example, is a substrate possessing a single textured face, the texture of which is that corresponding to that obtained for one of the faces of the Albarino-T™ glass of comparative example 3. The substrate has an average slope equal to 2°.

Example 5, which is a comparative example, is a substrate one of the textured faces of which was obtained using the printing roller of textured surface of examples 1 and 2, and the opposite textured face of which was obtained using a roller identical to that procuring one of the textured surfaces of the Albarino-T™ glass of example 3. The substrate of example 5 has a first average slope Pm1 of 1°, and a second average slope Pmt of 2°, leading the sum of the average slopes to equal 3°.

TABLE 1

| | Height Rz | Average | Pm (°) or sum of | TLH | ΔTLH | Haze (% at |
|---|---|---|---|---|---|---|
| Example n° | (μm) | Rsm(mm) | the Pm values (°) | (%) | (%) | 1.5°) |
| Diamant ™ | — | — | 0° | 84 | — | — |
| float glass | | | | | | |
| Example 1 | 5.6 | 0.53 | Pm = 1° | 83.7 | 0.3 | 5 |
| Example 2 | 5.6 | 0.53 | Sum of the Pm | 83.5 | 0.5 | 8 |
| | | | values = 2° | | | |
| Example 3- | 25 on one | 0.8 on one | Sum of the Pm | 83 | 1 | 19 |
| Albarino- | face/13 on | face/1.1 on | values = 3.5° | | | |
| T ™ | the other | the other | | | | |
| | face | face | | | | |
| Example 4 | 25 | 0.8 | Pm = 2° | 83.5 | 0.5 | 11 |
| Example 5 | 5.6 on one | 0.53 on one | Sum of the Pm | 83.2 | 0.8 | 14 |
| | face/25 on | face/0.8 on | values = 3 | | | |
| | the other | the other | | | | |
| | face | face | | | | |

It is observed that example 1 of the invention with an average slope lower than 2°, in particular equal to 1°, is entirely suitable for obtaining the sought-after result, a high TLH with a loss of TLH of less than 1% (in particular of 0.3%), and a haze of 5%, i.e. lower than 10%.

Likewise, example 2 of the invention with a sum of the average slopes lower than 3°, in the present case equal to 2°, corresponds to the desired results with a loss of TLH of 0.5% (therefore lower than 1%) and a haze of 8% (therefore lower than 10%).

In contrast, comparative example 3 shows that with average slopes on each textured face of 2° and 1.5° respectively giving a sum of the average slopes that is not lower than 3°, the result is not achieved, the haze of the substrate being too significant because it is 19%.

Likewise, comparative example 4 with a single textured face that has an average slope of 2° admittedly possesses a loss of TLH of less than 1% but already possesses a significant haze higher than 10%. This substrate is not suitable.

Likewise, comparative example 5 shows that with two textured faces of average slopes that are however low, respectively 1° and 2°, but the sum of which is not lower than 3°, the result is not achieved. The loss of TLH is admittedly 0.8% but the haze is too significant with 14% (therefore higher than 10%).

Table 2 provides an estimation of the haze value in transmission at 1.5° of an extra-clear Albarino matrix comprising a single textured surface, as a function of its average slope Pm.

This estimation is firstly based on an approximation made of the definition of the slope as a function of roughness parameters, according to the following equation:

$$θ = {tan}^{- 1} \frac{2 Rz}{Rsm}$$

As specified at the start of this text, the parameter Rz corresponds to the maximum height of the profile over an evaluation length l, whereas the parameter Rsm corresponds to an average period of the profile over an evaluation length l. Considering the structure to be relatively uniform, an approximation may be made of Rz as being equal to the average height over the evaluation length. It is then possible to relate the average slope Pm to the values of Rsm and of Rz using the following equation, this leading us to the preceding expression of the slope as a function of roughness parameters.

$$tan θ = \frac{Rz \text{/} 2}{Rsm \text{/} 4}$$

The estimation of the haze value is based in addition on a second assumption made as to the distribution of slopes having, when considered in their entirety, the desired average-slope value (target value) Pm. To do this, firstly, among the existing sample measurements, the measured sample having the average slope closest to this target value is selected. Subsequently an expansion coefficient is applied to the distribution function of the slopes of this sample in order to simulate a new slope distribution having the target average-slope value. Lastly, the haze associated with this modeled slope distribution is calculated.

TABLE 2

| Example no | Rsm/Rz | Pm (°) | Haze (% at 1.5°) |
|---|---|---|---|
| 1 | 572 | 0.2 | 0 |
| 2 | 381 | 0.3 | 0 |
| 3 | 229 | 0.5 | 0.5 |
| 4 | 163 | 0.7 | 0.5 |
| 5 | 127 | 0.9 | 0.5 |
| 6 | 114 | 1 | 1 |
| 7 | 104 | 1.1 | 1 |
| 8 | 95 | 1.2 | 1 |
| 9 | 88 | 1.3 | 1.5 |
| 10 | 81 | 1.4 | 1.5 |
| 11 | 76 | 1.5 | 2 |
| 12 | 71 | 1.6 | 2.7 |
| 13 | 67 | 1.7 | 3.2 |
| 14 | 63 | 1.8 | 4.5 |

The results of table 2 show that, for each of examples n° 1 to 14, for which the slope value is lower than 1.8°, a haze lower than 5% is obtained, the haze value increasing at the same time as the average slope Pm.

Table 3 provides an estimation of the haze value in transmission at 1.5° of an Albarino extra-clear matrix comprising two opposite textured surfaces, as a function of the sum of the average slopes (Pm1, Pm2) of each of these faces. This estimation is made on the basis of the assumptions having permitted the results presented in table 2 to be obtained.

TABLE 3

| | | | Sum of Pm1 and | | Haze (% |
|---|---|---|---|---|---|
| Example no | Pm1 (°) | Pm2 (°) | Pm2 values (°) | Rsm/Rz | at 1.5°) |
| 1 | 0.27 | 0.27 | 0.54 | 212 | 0 |
| 2 | 0.63 | 0.63 | 1.26 | 90 | 1 |
| 3 | 1 | 0.88 | 1.88 | 60 | 2.7 |
| 4 | 0.76 | 0.76 | 1.52 | 75 | 2.8 |
| 5 | 1 | 1 | 2 | 57 | 3.2 |
| 6 | 1.2 | 0.88 | 2.08 | 55 | 3.5 |
| 7 | 1.2 | 0.7 | 1.9 | 60 | 3.8 |
| 8 | 1.5 | 0.88 | 2.38 | 48 | 5 |
| 9 | 1.2 | 1.2 | 2.4 | 47 | 6.5 |
| 10 | 1.4 | 1 | 2.4 | 47 | 6 |
| 11 | 1.5 | 1 | 2.5 | 45 | 6 |
| 12 | 1.8 | 1.5 | 3.3 | 34 | 15.7 |
| 13 | 1.8 | 1.8 | 3.6 | 31 | 19.4 |

The results of table 3 show that a haze lower than 5% at 1.5° is obtained for each of examples n° 1 to 7, for which the sum of the slopes is lower than 2.3°. Examples n° 8 to 11, for which the sum of the slopes is lower than 3°, allow for their part a haze lower than 10% to be obtained. Lastly, examples n° 12 and 13 have a haze higher than 10% and therefore do not solve the general technical problem of the invention.

In conclusion, using the rolling process with suitable roughnesses of the imprinting surfaces of the rollers, combined with the implementation parameters of the process, the invention provides transparent substrates that have patterns in relief such that the average slope procures a high TLH and a very low haze, approaching the properties of a float glass, while being aesthetic, the patterns being discrete in size and distributed over all the surface so as to generate a uniform surface appearance.

According to one particular embodiment, the invention also relates to a horticultural greenhouse equipped with at least one substrate such as those described above.

1. A transparent substrate comprising a texture in relief on at least one of its two main faces, such that
when the substrate is textured on a single face, the average slope Pₘ in degrees of the textured face is lower than 2°, and
when the substrate is textured on both its faces, each of the faces having a respective average slope (Pm1, Pm2), the sum of the two average slopes of the respective faces is lower than 3°, and preferably lower than 2.5°.

2. The substrate as claimed in claim 1, wherein:
when the substrate is textured on a single face, the average slope Pm in degrees of the textured face is lower than 1.8°,
when the substrate is textured on both its faces, each of the faces having a respective average slope (Pm1, Pm2), the sum of the two average slopes of the respective faces is lower than 2.5°.

3. The substrate as claimed in claim 1, wherein the refractive index of the material comprising the texture is comprised between 1.4 and 1.65 at a wavelength of 587 nm.

4. The substrate as claimed in claim 1, wherein the material comprising the texture is made of mineral glass.

5. The substrate as claimed in claim 1, wherein the texture of said at least one substrate comprises patterns the period of which is such that the average Rsm is lower than 5 mm.

6. The substrate as claimed in claim 1, wherein:
when the substrate is textured on a single face, the average slope Pm in degrees of the textured face is higher than 0.3°,
when the substrate is textured on both its faces, each of the faces having a respective average slope (Pm1, Pm2), the sum of the two average slopes of the respective faces is higher than 0.6°.

7. The substrate as claimed in claim 1, further comprising an antireflection coating on one or both of its main faces.

8. The substrate as claimed in claim 1, wherein the texture is obtained by rolling the material from which the substrate is made between two rollers, a first roller being of smooth surface and a second roller being of textured surface, or both rollers being of textured surface.

9. The substrate as claimed in claim 1, wherein the texture may be produced in a first material placed on a substrate of a second material.

10. A horticultural greenhouse equipped with at least one substrate as claimed in claim 1.

11. A process for manufacturing a substrate as claimed in claim 1, the process comprising rolling a material from which the substrate is made between two rollers, either between a roller of smooth surface and a textured roller with patterns, or between two textured rollers with patterns.

12. The process for manufacturing a substrate as claimed in claim 11, wherein at least one of the textured roller and the two textured rollers with patterns is obtained by electrical discharge machining.

13. The substrate as claimed in claim 1, wherein the sum of the two average slopes of the respective faces is lower than 2.5°.

14. The substrate as claimed in claim 2, wherein:
when the substrate is textured on a single face, the average slope Pm in degrees of the textured face is lower than 1.3°,
when the substrate is textured on both its faces, each of the faces having a respective average slope (Pm1, Pm2), the sum of the two average slopes of the respective faces is lower than 1.3°.

15. The substrate as claimed in claim 4, wherein the mineral glass comprises iron oxide in a total weight content (expressed in Fe₂O₃) of at most 0.030%.

16. The substrate as claimed in claim 4, wherein the mineral glass is a soda-lime-silica glass with the following weight composition:
SiO₂ 50-75%
CaO 5-15%
MgO 0-10%
Na₂O 10-20%
Al₂O₃ 0-5%
K₂O 0-5%.

17. The substrate as claimed in claim 5, wherein the texture of said at least one substrate comprises patterns the period of which is such that the average Rsm is lower than 550 μm.

18. The substrate as claimed in claim 6, wherein:
when the substrate is textured on a single face, the average slope Pm in degrees of the textured face is higher than 1.1°,
when the substrate is textured on both its faces, each of the faces having a respective average slope (Pm1, Pm2), the sum of the two average slopes of the respective faces is higher than 1.1°.

19. The substrate as claimed in claim 7, wherein the antireflection coating is placed against said at least one textured face.

20. The process for manufacturing a substrate as claimed in claim 11, wherein at least one of the textured roller and the two textured rollers possessing imprinting patterns has an average slope higher than an average slope of the associated patterns obtained on the substrate.
